(19) United States
(12) Patent Application Publication
(10) Pub. No.: US 2013/0190473 A1
(43) Pub. Date: Jul. 25, 2013

(54) TONER FOR ELECTROSTATIC IMAGE DEVELOPMENT

(71) Applicants: Hiroshi NAGASAWA, Tokyo (JP); Kouji SUGAMA, Tokyo (JP); Hiroyuki KONNO, Tokyo (JP); Takaki KAWAMURA, Tokyo (JP)

(72) Inventors: Hiroshi NAGASAWA, Tokyo (JP); Kouji SUGAMA, Tokyo (JP); Hiroyuki KONNO, Tokyo (JP); Takaki KAWAMURA, Tokyo (JP)

(73) Assignee: KONICA MINOLTA BUSINESS TECHNOLOGIES, INC., Tokyo (JP)

(21) Appl. No.: 13/745,428

(22) Filed: Jan. 18, 2013

(30) Foreign Application Priority Data
Jan. 23, 2012 (JP) 2012-010578

(51) Int. Cl. G03G 9/087

(52) U.S. Cl. CPC G03G 9/08771
USPC 528/390

(57) ABSTRACT

Disclosed is a toner for electrostatic image development that has low-temperature fixability and hot offset resistance and also has document offset resistance. The toner contains a hyperbranched polymer which is a homopolymer formed using an inimer having, in its molecule, a polymerizable functional group and a polymerization initiating group or is a copolymer formed using the inimer and a vinyl-based monomer. The hyperbranched polymer is preferably a terminal-modified hyperbranched polymer and is preferably obtained by a living radical polymerization process.

### TECHNICAL FIELD

The present invention relates to a toner for electrostatic image development, which is used in image formation of an electrophotographic system.

### BACKGROUND ART

There is a need for electrophotographic image forming apparatuses with high energy efficiency and low running costs. Therefore, the development of apparatuses in which fixing temperature is set to be low is being actively performed.

Low temperature fixable toners for electrostatic image development that are usable for such apparatuses (hereinafter simply referred to also as “toners”) have some practical problems. More specifically, one problem when a low-temperature fixable toner is used for an image forming apparatus for high-speed mass printing is that, if fusion of the toner during fixation advances to the extent that its viscosity decreases significantly, part of the fused toner is transferred to a fixing member, causing a hot offset phenomenon.

To achieve both low-temperature fixability and hot offset resistance simultaneously, studies focused on binder resins making up toners are being performed, and various proposals have been made.

For example, Patent Literatures 1 and 2 propose the use of a crystalline resin as the binder resin for a toner.

For example, Patent Literature 3 proposes the use of a resin with a broad molecular weight distribution as the binder resin for a toner, more specifically a partially crosslinked polyester resin containing a solvent-insoluble component.

In particular, to improve the not offset resistance, a resin with a broad molecular weight distribution is used. Such a resin with a broad molecular weight distribution has a branched structure but is categorized as a linear polymer because of the constraint that the resin is produced without gelation.

Other known highly branched polymers other than such a linear polymer include a hyperbranched polymer that is grown while undergoing branching repeatedly during polymerization. Such a hyperbranched polymer has a large number of terminal groups on the outer side of its molecule but is not in a gel form and exhibits thermoplasticity.

It is known that a hyperbranched polymer is synthesized by polymerization of ABx-type molecules (A and B are different organic groups having different functional groups “a” and “b,” and the functional groups “a” and “b” can chemically undergo a condensation reaction and an addition reaction with each other. x is an integer of 2 or larger.) (see Non-Patent Literatures 1 and 2). It is also known that, to polymerize the ABx-type molecules, AB-type molecules (a compound having one organic group A and one organic group B in its molecule) are copolymerized (see, for example, Patent Literature 4).

However, the types of usable ABx monomers and AB monomers are limited, and it is very difficult to increase the glass transition point and molecular weight of a hyperbranched polymer while gelation is suppressed.

Another problem when a toner with excellent low-temperature fixability is used for an image forming apparatus for high-speed mass printing is that, since printed sheets are stacked with heat-fixed images not cooled sufficiently, a document offset phenomenon occurs in which offset of the toner forming the images occurs in the stacked printed sheets.

A hyperbranched polymer disclosed in Patent Literature 5 is used as a cross-linking agent that is allowed to react with a liner polyester resin and has a broad molecular weight distribution, as does the resin disclosed in Patent Literature 3 above. Therefore, the hyperbranched polymer contributes to hot offset resistance, but the characteristics of the hyperbranched polymer are not effectively utilized for fixability.

### CITATION LIST

### Patent Literature

Patent Literature 1: Japanese Patent Publication Sho. 56-13943
Patent Literature 2: Japanese Patent Application Laid-Open No. 2004-168827
Patent Literature 3: Japanese Patent Application Laid-Open No. 2002-328491
Patent Literature 4: Japanese Patent Application Laid-Open No. 2008-203673
Patent Literature 5: Japanese Patent No. 2574201

### Non-Patent Literature

Non-Patent Literature 1: P. J. Flory (translated by Syoten Oka and Kisou Kanamaru), “Polymer chemistry,” Chapter 9, Maruzen, 1956
Non-Patent Literature 2: Koji Ishizu, “Nanotechnology of Branched Polymers,” Chapter 6, Industrial Publishing & Consulting, Inc., 2000

### SUMMARY OF INVENTION

### Technical Problem

The present invention has been made in view of the foregoing circumstances and has as its object the provision of a toner for electrostatic image development that has low-temperature fixability and also has document offset resistance and hot offset resistance.

### Solution to Problem

To achieve the abovementioned object, a toner for electrostatic image development reflecting one aspect of the present invention contains a hyperbranched polymer which is a homopolymer formed using an inimer having, in a single molecule thereof, a polymerizable functional group and a polymerization initiating group or is a copolymer formed using the inimer and a vinyl-based monomer.

In the toner for electrostatic image development of the present invention, the hyperbranched polymer may be a terminal-modified hyperbranched polymer.

In the toner for electrostatic image development of the present invention, the hyperbranched polymer may preferably be obtained by a living radical polymerization process.

In the toner for electrostatic image development of the present invention, the living radical polymerization process may preferably be an atom transfer radical polymerization (ATRP) process or a thermal polymerization process using a dithiocarbamate compound represented by the following formula formula (1):

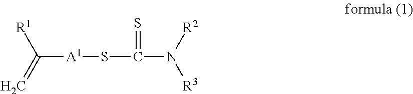

(in the formula (1), R¹ represents a hydrogen atom or a methyl group, R² and R³ each independently represent an alkyl group having 1 to 5 carbon atoms, a hydroxyalkyl group having 1 to 5 carbon atoms, or an arylalkyl group having 7 to 12 carbon atoms, R² and R³ may be bonded to each other to form a ring together with a nitrogen atom, and A¹ represents at least one of groups represented by the following formulas (2) and (3)),

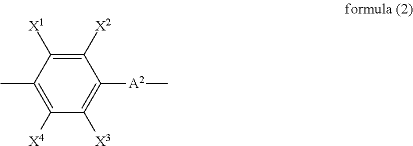

(in the formula (2), A² represents a linear, branched, or cyclic alkylene group having 1 to 30 carbon atoms and optionally having an ether bond or an ester bond, and X¹ to X⁴ each independently represent a hydrogen atom, an alkyl group having 1 to 20 carbon atoms, an alkoxy group having 1 to 20 carbon atoms, a halogen atom, a nitro group, a hydroxy group, an amino group, a carboxyl group, or a cyano group),

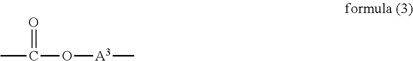

(in the formula (3), A³ represents a linear, branched, or cyclic alkylene group having 1 to 30 carbon atoms and optionally having an ether bond or an ester bond).

In the toner for electrostatic image development of the present invention, a linear equivalent mass-average molecular weight (MwL) of the hyperbranched polymer measured by gel permeation chromatography (GPC) is preferably 1,000 to 1,000,000, more preferably 2,000 to 500,000, particularly preferably 5,000 to 100,000.

The hyperbranched polymer may preferably have a degree of branching of 1.2 to 10.

The hyperbranched polymer may preferably have a polydispersity of 10 or less.

### Advantageous Effects of Invention

The toner of the present invention contains a hyperbranched polymer which is a homopolymer formed using an inimer having, in a single molecule thereof, a polymerizable functional group and a polymerization initiating group or is a copolymer formed using the inimer and a vinyl-based monomer. Therefore, the toner has low-temperature fixability and also has document offset resistance and hot offset resistance.

### DESCRIPTION OF EMBODIMENTS

The present invention will next be described in detail.

### Toner for Electrostatic Image Development:

The toner for electrostatic image development of the present invention comprises toner particles at least containing, as a binder resin, a hyperbranched polymer which is a homopolymer of an inimer having, in its molecule, a polymerizable functional group and a polymerization initiating group or is a copolymer of the inimer and a vinyl-based monomer.

In the present invention, the toner is aggregates of toner particles.

The toner particles making up the toner of the present invention contain a hyperbranched polymer as the binder resin and may further contain internal additives such as a colorant, a parting agent, a magnetic powder, and a charge control agent, if necessary.

The toner of the present invention may further contain external additives such as a flowability improver added externally to the toner particles.

### Binder Resin:

The toner particles making up the toner of the present invention contain a hyperbranched polymer as the binder resin and may further contain an additional resin.

### Hyperbranched Polymer:

In the toner of the present invention, the hyperbranched polymer is a homopolymer formed by polymerization of an inimer having, in its molecule, a polymerizable functional group and a polymerization initiating group or is a copolymer formed by copolymerization of the inimer and a vinyl-based monomer. The hyperbranched polymer in the present invention is a highly branched polymer that is grown while undergoing branching repeatedly during polymerization. The hyperbranched polymer has a large number of terminal groups on the outer side of its molecule but does not undergo gelation and has thermoplasticity.

No particular limitation is imposed on the inimer used to obtain the hyperbranched polymer in the present invention, so long as the inimer has, in its molecule, a polymerizable functional group and a polymerization initiating group.

The polymerization initiating group is a functional group that functions as a polymerization initiation site.

Examples of the polymerizable functional group contained in the inimer include functional groups derived from: styrene and styrene derivatives; methacrylate derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; acrylate derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; acrylic acid and methacrylic acid derivatives such as acrylamide; and vinyl-based monomers such as vinyl acetate and vinyl butyrate. Of these, functional groups derived from styrene derivatives, methacrylate derivatives, and acrylate derivatives are preferred from the viewpoint of reactivity.

Examples of the polymerization initiating group contained in the inimer include functional groups that generate radicals, cations, or anions under the action of heat, light, an oxidant, a reductant, a nucleophile, an electrophile, or a transition metal complex. Of these, a functional group that generates radicals is preferably used as the polymerizable functional group because of its wide application range. More preferably, the inimer has a functional group that functions as a polymerization initiation site in a publicly known living radical polymerization process. The living radical polymerization process may be referred to as a controlled radical polymerization process when the polymerization is not sufficiently controlled and the livingness of the polymerization is not sufficient. However, the reaction mechanisms and starting materials of these processes are not significantly different. Therefore, in the present invention, the living radical polymerization is used to include the controlled radical polymerization process.

Preferably, the hyperbranched polymer in the present invention has a multi-branched structure and a narrow molecular weight distribution. Preferably, to obtain such a hyperbranched polymer, living radical polymerization is used in order to suppress gelation due to a bimolecular termination reaction and a chain transfer reaction to a main chain and to suppress an increase in polydispersity described later. Preferably, the living radical polymerization process is an atom transfer radical polymerization (ATRP) process or a thermal polymerization process using a dithiocarbamate compound represented by the formula (1) because the inimer can be easily synthesized and the rate of polymerization can be easily controlled. The inimer used in each polymerization process will next be described in detail.

### Atom Transfer Radical Polymerization (ATRP) Process:

The atom transfer radical polymerization (ATRP) process is a radical polymerization process using a transition metal complex as a catalyst and an organic halogen compound as a polymerization initiator.

For example, to produce the hyperbranched polymer in the present invention by ATRP, any publicly known functional group serving as a polymerization initiation site during ATRP can be used as the polymerization initiating group contained in the inimer. From the viewpoint of the stability and availability of the inimer and the ease of dissociation of a halogen atom, the functional group may be any of a benzyl chloride group, a benzyl bromide group, functional groups derived from 2-chrolopropionate and 2-bromopropionate, etc.

No particular limitation is imposed on the inimer having the above-described polymerization initiating group, so long as the inimer is a compound having a vinyl group and a functional group (polymerization initiating group) serving as an ATRP initiation site. However, a compound represented by the following formula (4) is preferably used.

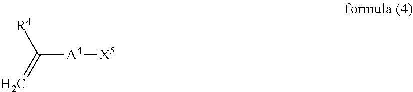

In the formula (4), R⁴ represents a hydrogen atom or a methyl group. A⁴ represents at least one of the groups represented by the formulas (2) and (3) above. X⁵ represents a functional group having the ability to accept an electron through one-electron transfer from a complex and then dissociate from the terminal to form a radical under polymerization conditions for ATRP. General examples of the group X⁵ include Cl, Br, I, SCN, and N₃. After the dissociation, a carbon radical is generated at the terminal of the group A⁴ from which the group X⁵ has dissociated, and a monomer is added to the terminal to start growing. Therefore, this terminal functions as an ATRP initiation site.

Examples of the compound represented by the formula (4) above include vinylbenzyl chloride (VBC), vinylbenzyl bromide, p-(1-chloroethyl)styrene, p-(1-chloropropyl)styrene, 1-methacryloyloxy-2-(2-bromopropyloyloxy)ethane, 1-methacryloyloxy-3-(2-bromopropyloyloxy)propane, 1-methacryloyloxy-4-(2-bromopropyloyloxy)butane, α-methacryloyl-ω-(2-bromopropyloyloxy)di(oxyethylene), α-methacryloyl-ω-(2-bromopropyloyloxy)tri(oxyethylene), and methacryloyl-ω-(2-bromopropyloyloxy)oligo (oxyethylene). Of these, vinylbenzyl chloride (VBC), vinylbenzyl bromide, p-(1-chloroethyl)styrene, 1-methacryloyloxy-2-(2-bromopropyloylozy)ethane, α-methacryloyl-ω-(2-bromopropyloyloxy)di(oxyethylene), etc. are preferably used from the viewpoint of the stability and availability of these compounds and the ease of dissociation of the halogen atom.

A ligand used to form an ATRP metal catalyst is appropriately selected according to a reaction solvent and the inimer. Generally, amine-based polydentate ligands such as 2,2′-bipyridine and compounds represented by the following formulas (5-1) to (5-4) are used. Of these, highly active ligands such as tris(2-(dimethylamino)ethyl)amine (Me_{ε}TREN) and tris(2-pyridylmethyl)amine (TPMA) are preferably used in order to reduce the amount of the catalyst used. The ATRP adopted is preferably ARGET (Activators ReGenerated by Electron Transfer)-ATRP, which is a process in which the catalyst is regenerated by a reductant in order to reduce the influence of dissolved oxygen and to reduce the amount of the catalyst used. The reductant may be added initially or during polymerization continuously or intermittently.

No particular limitation is imposed on the polymerization process. Any commonly used process such as bulk polymerization, solution polymerization, suspension polymerization, or emulsion polymerization may be used. From the viewpoint of suppressing gelation and an increase in polydispersity, solution polymerization is preferred.

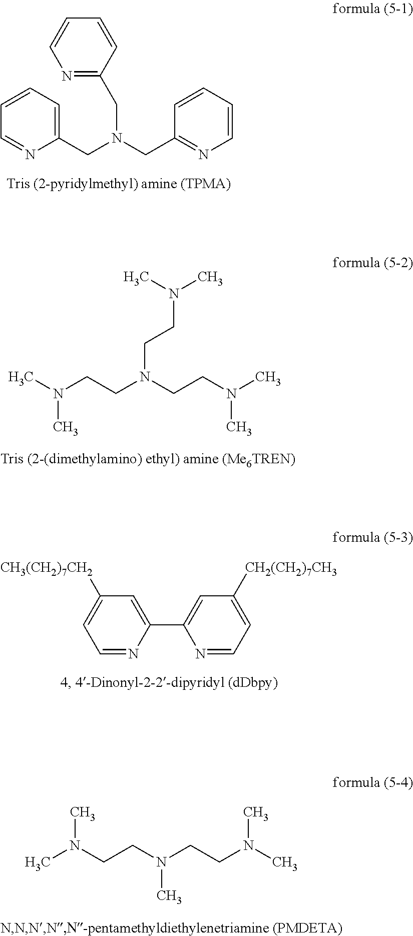

### Thermal Polymerization Process Using Dithiocarbamate Compound Represented by the Formula (1):

A thermal polymerization process using the dithiocarbamate compound represented by the formula (1) is a process in which the dithiocarbamate compound is polymerized under heating at 50 to 250° C.

The dithiocarbamate compound represented by the formula (1) can be obtained by a nucleophilic substitution reaction of the compound represented by the formula (4) above with a compound represented by the formula (6) below.

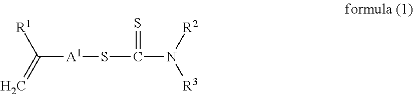

In the formula (1), R¹ represents a hydrogen atom or a methyl group. R² and R³ each independently represent an alkyl group having 1 to 5 carbon atoms, a hydroxyalkyl group having 1 to 5 carbon atoms, or an arylalkyl group having 7 to 12 carbon atoms. R² and R³ may be bonded to each other to form a ring together with a nitrogen atom. A₁ represents at least one of the groups represented by the formulas (2) and (3) above.

Examples of the dithiocarbamate compound represented by the formula (1) in which the group A¹ is the group represented by the formula (2) include N,N-diethyldithiocarbamylmethylstyrene and N,N-diethyldithiocarbamylethylstyrene.

Examples of the dithiocarbamate compound represented by the formula (1) in which the group A¹ is the group represented by the formula (3) include a compound obtained by substituting a hydroxyl group in a hydroxyl group-containing (meth)acrylate with a leaving group such as a fluoro group, a chloro group, a bromo group, an iode group, a mesyl group, or a tosyl group and then subjecting the resultant (meth)acrylate to a nucleophilic substitution reaction with the compound represented by the formula (6) below.

Examples of the hydroxyl group-containing (meth)acrylate include: hydroxyalkyl (meth)acrylates such as hydroxyethyl (meth)acrylate, hydroxypropyl (meth)acrylate, and hydroxybutyl (meth)acrylate; and polyalkylene oxide compounds having a hydroxyl group at their one end with the other end (meth)acrylated, such as polyethylene glycol mono (meth)acrylate and polypropylene glycol mono(meth)acrylate. Of these, hydroxyethyl (meth)acrylate and polyethylene glycol mono(meth)acrylate are preferred.

The dithiocarbamate compound represented by the formula (1) may also be obtained as follows. Polyethylene glycol mono(meth)acrylate is obtained by living polymerization of ethylene oxide (EO) using, as an initiator, an alkali metal salt of ethylene glycol mono(t-butyldimethylsilyl)ether, and then introducing a polymerizable functional group into the resulting polyethylene glycol using p-vinylbenzyl chloride or methacryloyl chloride. The resulting polyethylene glycol mono (meth)acrylate is reacted with the compound represented by the formula (6) with t-butyldimethylsilyl serving as a leaving group to obtain the dithiocarbamate compound. The dithiocarbamate compound represented by the formula (1) may also be obtained by the same process as above utilizing polypropylene glycol mono(meth)acrylate. As the dithiocarbamate compound represented by the formula (1), any of N,N-diethyldithiocarbamylmethylstyrene, 1-methacryloyloxy-2-(2-(N,N-diethyldithiocarbamyl)propyloyloxy)ethane, 1-(N,N-diethyldithiocarbamyl)-2-methacryloyloxyethane, and α-methacryloyl-ω-(N,N-diethyldithiocarbamyl)di(oxyethylene) is preferably used because of their stability, availability, and reactivity.

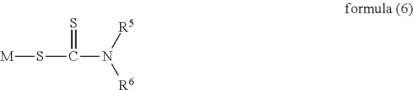

In the formula (6) above, M represents lithium, sodium, or potassium, and R⁵ and R⁶ each independently represent an alky group having 1 to 5 carbon atoms, a hydroxyalkyl group having 1 to 5 carbon atoms, or an arylalkyl group having 7 to 12 carbon atoms. R⁵ and R⁶ may be bonded to each other to form a ring together with a nitrogen atom.

The hyperbranched polymer in the present invention may be a homopolymer of the inimer or a copolymer of the inimer and a vinyl-based monomer.

No particular limitation is imposed on the vinyl-based monomer used as a comonomer for obtaining the copolymer. Examples of the vinyl-based monomer include: styrene and styrene derivatives; methacrylate derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; acrylate derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; acrylic acid and methacrylic acid derivatives such as acrylamide; and compounds derived from vinyl-based monomers such as vinyl acetate and vinyl butyrate. One of these vinyl-based monomers may be copolymerized with the inimer, or any combination thereof may be used.

To obtain a function derived from the branched structure, the copolymerization ratio of the inimer to the comonomer is preferably 5 to 100% by mass.

The terminals of the hyperbranched polymer in the present invention may be partially or entirely modified (such a hyperbranched polymer is hereinafter referred to as a “terminal-modified hyperbranched polymer”).

More specifically, a hyperbranched polymer with unmodified terminals (hereinafter referred to as an “unmodified hyperbranched polymer”) may be used alone as the binder resin, or the unmodified hyperbranched polymer may be used in combination with an additional resin described later. A terminal-modified hyperbranched polymer may be used alone or in combination with an additional resin. In addition, a combination of an unmodified hyperbranched polymer with a terminal-modified hyperbranched polymer may also be used. In the toner of the present invention, a terminal-modified hyperbranched polymer is preferably used alone or in combination with an additional resin from the viewpoint of the controllability of the surface properties, electrification properties, morphology, etc. of toner particles to be formed.

The terminal-modified hyperbranched polymer can be produced by, for example, a process in which an unmodified hyperbranched polymer is modified through a substitution reaction of its polymerization initiating group with a low-molecular weight compound or a reactive polymer or a process in which the polymerization initiating group of an unmodified hyperbranched polymer and a vinyl-based monomer are polymerized. From the viewpoint of reactivity and the necessity of purification before the modification reaction, a process in which the polymerization initiating group of an unmodified hyperbranched polymer and a vinyl-based monomer are polymerized is preferred. Examples of the vinyl-based monomer used to obtain such a terminal-modified hyperbranched polymer include those exemplified for the comonomers for obtaining the above copolymer.

Preferably, the hyperbranched polymer in the present invention has a degree of branching in the range of 1.2 to 10. The degree of branching is defined as “mass average molecular weight (MwB)/linear equivalent mass-average molecular weight (MwL)”. The mass average molecular weight (MwB) is measured by a GPC/multi-angle laser light scattering (MALLS) method, and the linear equivalent mass-average molecular weight (MwL) is measured by gel permeation chromatography (GPC) of a THF soluble component.

If the degree of branching is less than 1.2, the strength and flowability of the hyperbranched polymer become low, and the entanglement of the hyperbranched polymer and molecular chains of other components in the binder resin becomes insufficient. Therefore, the occurrence of the document offset phenomenon may not be sufficiently suppressed. If the degree of branching exceeds 10, the hyperbranched polymer tends to be in a gel form, and the toner to be obtained cannot be formed into a desired shape in the production process of the toner because of its low shape controllability. Therefore, the toner obtained has low transferability, and the quality of images to be formed may deteriorate.

Although quantitative analysis may be difficult, peaks due to the branch structure of the hyperbranched polymer can be observed using a method that allows NMR signals from different components to be separated from each other on the basis of differences in molecular weight or diffusion coefficient determined by GPC-NMR or DOSY.

The hyperbranched polymer in the present invention has a polydispersity of preferably 10 or less, more preferably 5 or less. The polydispersity is defined as “linear equivalent mass-average molecular weight (MwL)/number average molecular weight (Mn).” The linear equivalent mass-average molecular weight (MwL) is measured by GPC.

If the polydispersity is excessively large, part of the hyperbranched polymer may form a gel. The formed gel may cause an increase in melt viscosity, resulting in deterioration of low-temperature fixability.

The linear equivalent mass-average molecular weight (MwL) measured by GPC is preferably 1,000 to 1,000,000, more preferably 2,000 to 500,000, still more preferably 5,000 to 100,000.

If the linear equivalent mass-average molecular weight (MwL) is excessively small, sufficient hot offset resistance and document offset resistance may not be obtained. If the linear equivalent mass-average molecular weight (MwL) is excessively large, the low-temperature fixability may deteriorate.

In the present invention, the measurement conditions in the above GPC and GPC/MALLS are as follows.

### —Measurement Conditions—

### [GPC]

Apparatus: HLC-8220GPC, Tosoh Corporation

Columns: Shodex KF-804L+KF-803L

Column temperature: 40° C.

Solvent: tetrahydrofuran

Detector: UV-254 nm, RI

### [GPC/MALLS]

Apparatus: Wyatt DAWN HELEOS

Measurement temperature: 40° C.

The content of the hyperbranched polymer in the present invention in the binder resin is preferably 1 to 100% by mass, more preferably 10 to 100% by mass.

When the content of the hyperbranched polymer is within the above range, low-temperature fixability and hot offset resistance are achieved, and also document offset resistance can be reliably achieved.

### Additional Resin:

The toner particles making up the toner of the present invention may contain, in addition to the hyperbranched polymer, an additional resin as a binder resin. Examples of the additional resin include styrene-acrylic copolymer resins and polyester resins.

Examples of the polymerizable monomers that form a styrene-acrylic copolymer resin used as the additional resin include: styrene and styrene derivatives such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene; methacrylate derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; acrylate derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; olefins such as ethylene, propylene, and isobutylene; halogenated vinyls such as vinyl chloride, vinylidene chloride, vinyl bromide, vinyl fluoride, and vinylidene fluoride; vinyl esters such as vinyl propionate, vinyl acetate, and vinyl benzoate; vinyl ethers such as vinyl methyl ether and vinyl ethyl ether; vinyl ketones such as vinyl methyl ketone, vinyl ethyl ketone, and vinyl hexyl ketone; N-vinyl compounds such as N-vinylcarbazole, N-vinylindole, and N-vinylpyrrolidone; vinyl compounds such as vinylnaphthalene and vinylpyridine; and acrylic acid and methacrylic acid derivatives such as acrylonitrile, methacrylonitrile, and acrylamide. These may be used either singly or in any combination thereof.

The mass average molecular weight (Mw) of such a styrene-acrylic copolymer resin is preferably 5,000 to 50,000, more preferably 8,000 to 20,000, and the ratio of the mass average molecular weight (Mw) to the number average molecular weight (Mn) (Mw/Mn) is preferably 1.0 to 3.5.

In the present invention, the molecular weight of the additional resin is measured by GPC.

More specifically, the molecular weight is measured using an apparatus “HLC-8220” (manufactured by Tosoh Corporation) and a column “TSKguardcolumn+TSKgel SuperHZM-M (three in series)” (manufactured by Tosoh Corporation) in the flow of tetrahydrofuran (THF) used as a carrier solvent at a flow rate of 0.2 mL/min while the temperature of the column is held at 40° C. A sample (resin) is dissolved in THF at a concentration of 1 mg/mL using an ultrasonic disperser. In this case, the dissolving treatment is performed at room temperature for 5 minutes. Next, the obtained solution is treated through a membrane filter having a pore size of 0.2 μm to obtain a sample solution, and 10 μL of the sample solution together with the above-described carrier solvent is injected into the apparatus. Detection is performed using a refractive index detector (RI detector), and the molecular weight distribution of the sample is computed using a calibration curve determined using monodispersed polystyrene standard particles. Ten different types of polystyrene are used for the determination of the calibration curve.

When a polyester resin is used as the additional resin, the polyester resin can be obtained from a publicly known polyalcohol and a publicly known polyvalent carboxylic acid.

Examples of the polyalcohol include: aliphatic diols such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol; bisphenols such as bisphenol A and bisphenol F; and alkylene oxide adducts of these bisphenols such as ethylene oxide adducts and propylene oxide adducts. Examples of trihydric or higher alcohols include glycerin, pentaerythritol, trimethylolpropane, and sorbitol. Examples of polyalcohols having an unsaturated group include: polyalcohols having an unsaturated double bond such as 2-butene-1,4-diol, 3-butene-1,6-diol, 4-butene-1,8-diol, and 9-octadecene-7,12-diol; and polyalcohols having an unsaturated triple bond such as 2-butyne-1,4-diol and 3-butyne-1,4-diol. These polyalcohols may be used either singly or in any combination thereof.

Examples of the polyvalent carboxylic acid include aliphatic carboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarbozylic acid, 1,12-dodecanedicarboxylic acid, 1,13-tridecanedicarboxylic acid, 1,1,4-tetradecanedicarboxylic acid, 1,16-hexadecanedicarboxylic acid, and 1,18-octadecanedicarboxylic acid; lower alkyl esters and acid anhydrides of these aliphatic carboxylic acids; aromatic carboxylic acids such as phthalic acid, isophthalic acid, terephthalic acid, o-phthalic acid, t-butyl isophthalic acid, 2,6-naphthalene dicarboxylic acid, and 4,4′-biphenyl dicarboxylic acid; and trivalent or higher carboxylic acids such as trimellitic acid and pyromellitic acid. Examples of polyvalent carboxylic acids having an unsaturated group include: unsaturated aliphatic carboxylic acids such as maleic acid, fumaric acid, itaconic acid, citraconic acid, glutaconic acid, isododecenyl succinic acid, n-dodecenyl succinic acid, and n-octenyl succinic acid; acid anhydrides and acid chlorides thereof; and unsaturated aromatic carboxylic acids such as caffeic acid. These polyvalent carbolic acids may be used either singly or in any combination thereof.

In the present invention, when a polyester resin is used as the binder resin, polycondensed phthalic acid is preferably used.

The mass average molecular weight (Mw) of such a polyester resin is preferably 1,000 to 50,000, more preferably 2,000 to 30,000.

### Colorant:

The toner particles making up the toner of the present invention may contain a colorant. The colorant used may be any of various publicly known colorants such as carbon black, black iron oxide, dyes, and other pigments.

Examples of the carbon black include channel black, furnace black, acetylene black, thermal black, and lamp black. Examples of the black iron oxide include magnetite, hematite, and iron titanium trioxide.

Examples of the dyes include C.I. Solvent Red: 1, 49, 52, 58, 63, 111, and 122, C.I. Solvent Yellow: 19, 44, 77, 79, 81, 82, 93, 98, 103, 104, 112, and 162, and C.I. Solvent Blue: 25, 36, 60, 70, 93, and 95.

Examples of the pigments include C.I. Pigment Red: 5, 48:1, 48:3, 53:1, 57:1, 81:4, 122, 139, 144, 149, 150, 166, 177, 178, 222, 238, and 269, C.I. Pigment Orange: 31 and 43, C.I. Pigment Yellow: 14, 17, 74, 93, 94, 138, 155, 156, 158, 180, and 185, C.I. Pigment Green: 7, and C.I. Pigment Blue: 15:3 and 60.

One colorant or a combination of two or more colorants may be used for each color toner.

The content of the colorant is preferably 1 to 30 parts by mass, more preferably 2 to 20 parts by mass per 100 parts by mass of the binder resin.

If the content of the colorant is excessively small, the toner obtained may not have the desired coloring power. If the content of the colorant is excessively large, the colorant may be separated or adhere to a carrier etc., and this may affect electrification characteristics.

### Parting Agent:

The toner particles making up the toner of the present invention may optionally contain a parting agent, and the parting agent used may be any of various publicly known waxes. Specific examples of such waxes include polyolefin waxes such as low molecular weight polypropylene, low molecular weight polyethylene, oxidized type polypropylene, and oxidized type polyethylene.

The content of the parting agent is preferably 1 to 30 parts by mass, more preferably 1 to 20 parts by mass per 100 parts by mass of the binder resin.

### Magnetic Powder:

The toner particles making up the toner of the present invention may optionally contain a magnetic powder. Various types of ferrites such as magnetite and γ-hematite may be used as the magnetic powder.

The content of the magnetic powder is preferably 30 to 200 parts by mass, more preferably 60 to 200 parts by mass per 100 parts by mass of the binder resin.

### Charge Control Agent:

The toner particles making up the toner of the present invention may optionally contain a charge control agent. No particular limitation is imposed on the charge control agent, so long as it can impart positive or negative charge by triboelectrification. The charge control agent used may be any of various publicly known charge control agents for positive electrification and charge control agents for negative electrification.

The content of the charge control agent is preferably 0.1 to 30 parts by mass, more preferably 0.1 to 10 parts by mass per 100 parts by mass of the binder resin.

### External Additives:

The toner of the present invention can be used without adding any other additives. However, to improve flowability, electrification characteristics, cleanability, etc., the toner may be used with external additives such as a flowability improver and a cleaning aid added to the toner particles.

Examples of the flowability improver include fine inorganic particles of silica, alumina, titanium oxide, zinc oxide, iron oxide, copper oxide, lead oxide, antimony oxide, yttrium oxide, magnesium oxide, barium titanate, ferrite, iron red, magnesium fluoride, silicon carbide, boron carbide, silicon nitride, zirconium nitride, magnetite, and magnesium stearate.

Preferably, these fine inorganic particles have been subjected to surface treatment with a silane coupling agent, a titanium coupling agent, a higher fatty acid, or silicone oil in order to improve dispersibility over the surfaces of the toner particles and to improve environmental stability.

Examples of the cleaning aid include fine polystyrene particles and fine polymethyl methacrylate particles.

A combination of various external additives may be used.

The amount of the external additives added is preferably 0.05 to 5 parts by mass, more preferably 0.1 to 3 parts by mass per 100 parts by mass of the toner particles.

### Particle Diameter of Toner:

The toner of the present invention has a particle diameter of preferably 3 to 9 μm as a volume-based median diameter, more preferably 5 to 7 μm.

When the volume-based median diameter of the toner is in the above range, high transfer efficiency is achieved, and the quality of a halftone image is improved. In addition, the image quality of fine lines and dots is improved.

In the present invention, the volume-based median diameter of the toner is measured and computed using a measuring device composed of “Coulter Multisizer 3” (manufactured by Beckman Coulter, Inc.) and a computer system connected thereto and equipped with data processing software “Software V3.51.”

More specifically, 0.02 g of the sample (the toner) is added to 20 mL of a surfactant solution (a surfactant solution used for the purpose of dispersing the toner particles and obtained, for example, by diluting a neutral detergent containing a surfactant component ten-fold with pure water). After the mixture is caused to be intimate, ultrasonic dispersion is performed for 1 minute to prepare a dispersion. This dispersion is added with a pipette to a beaker containing “ISOTON IT” (manufactured by Beckman Coulter, Inc.) and held in a sample stand until the concentration displayed on the measuring device reaches 8%. By using the above concentration range, a reproducible measurement value can be obtained. In the measuring device, the number of particles to be counted is set to 25,000, and the diameter of an aperture is set to 50 μm. The range of measurement (1 to 30 μm) is divided into 256 sections, and a frequency value in each section is computed. The particle diameter when a cumulative volume fraction cumulated from the largest volume fraction is 50% is used as the volume-based median diameter.

### Average Circularity of Toner:

From the viewpoint of achieving both an improvement in transfer efficiency and cleanability simultaneously, the toner of the present invention has an average circularity of preferably 0.930 to 1.000, more preferably 0.95 to 0.98.

In the present invention, the average circularity of the toner is measured using a flow-type particle image analyzer “FPIA-2100” (manufacture by Sysmex Corporation).

More specifically, the sample (the toner) is caused to be intimate in a surfactant-containing aqueous solution and then subjected to ultrasonic dispersion treatment for 1 minute to disperse the toner. Then images of the toner are taken using the “FPIA-2100” (manufacture by Sysmex Corporation) in an HPF (high-power field) measurement mode at an appropriate concentration (the number of particles detected in the HPF mode: 3,000 to 10,000). The circularities of the particles are computed using the following formula (T) and summed up, and the total is divided by the total number of toner particles.

circularity=(perimeter of circle having the same area as the particle image)/(perimeter of projected particle image) Formula (T):

### Glass Transition Point:

The glass transition point of the toner of the present invention is preferably 20 to 50° C., more preferably 30 to 45° C.

In the present invention, the glass transition point is measured using a differential scanning calorimeter “Diamond DSC” (manufactured by PerkinElmer Co., Ltd.). More specifically, 4.5 mg of the sample (the toner) is precisely weighed to the second decimal place and sealed in an aluminum-made pan, and the pan is placed in a DSC-7 sample holder. An empty aluminum-made pan is used as a reference. A heating-cooling-heating cycle is performed in the measurement temperature range of 0 to 200° C. while the temperature is controlled at a temperature increase rate of 10° C./min and a temperature decrease rate of 10° C./min. Analysis is performed based on data in the 2nd heating. The intersection of the extension of a base line before the rising edge of a first endothermic peak and a tangential line representing the maximum inclination between the rising edge of the first endothermic peak and the top of the peak is used as the glass transition point.

### Softening Point:

The softening point of the toner of the present invention is preferably 90 to 120° C., more preferably 90 to 100° C.

In the present invention, the softening point is measured as follows. Specifically, 1.1 g of the sample (the toner) is placed in a petri dish under an environment of 20±100 and 50±5% RH and then is leveled off. After left to stand for 12 hours or longer, the sample is pressurized using a press “SSP-10A” (manufactured by Shimadzu Corporation) at a pressure of 3,820 kg/cm for 30 seconds to produce a cylindrical molded sample having a diameter of 1 cm. Then the molded sample is placed in a flow tester “CFT-500D” (manufactured by Shimadzu Corporation) in an environment of 24±5° C. and 50±20% RH. Under the conditions of a load of 196 N (20 kgf), a start temperature of 60° C., a preheating time of 300 seconds, and a temperature increase rate of 6° C./min, the molded sample is extruded from the hole (1 mm diameter×1 nm) of a cylindrical die using a piston having a diameter of 1 cm after completion of preheating. An offset temperature T_{offset} measured by a melting point measurement method of a temperature rise method at an offset value setting of 5 mm is used as the softening point.

### Production Process of Toner:

Examples of a production process of the toner of the present invention include a kneading-pulverizing process, a suspension polymerization process, an emulsion aggregation process, a dissolution suspension process, a polyester extension process, and a dispersion polymerization process.

Of these, the emulsion aggregation process is preferably used from the viewpoint of uniformity of the particle diameter, shape controllability, and the ease of forming a core-shell structure, which are advantageous for high image quality and high stability.

With the emulsion aggregation process, toner particles are produced by preparing a dispersion of fine resin particles dispersed using a surfactant or a dispersion stabilizer, optionally mixing the dispersion with a dispersion of a toner particle-forming component such as fine colorant particles, adding an aggregating agent to aggregate the toner particles until the desired diameter is achieved, and fusing the fine resin particles during or after aggregation to control the shape of the particles.

The fine resin particles may optionally contain internal additives such as a parting agent and a charge control agent or may be composite particles including a plurality of layers, i.e., two or more layers formed of different resins with different compositions.

From the viewpoint of the design of the structure of the toner, it is preferable to add different types of fine resin particles during aggregation to form toner particles having the core-shell structure.

The fine resin particles can be produced by, for example, an emulsion polymerization process, a miniemulsion polymerization process, or a phase-transfer emulsification process or by a combination of some production processes.

### Dry Developer:

The toner of the present invention may be a one-component developer composed only of a magnetic or non-magnetic toner or a two-component developer composed of a mixture of a toner and a carrier.

When the toner of the present invention is used as a two-component developer, the carrier used may be magnetic particles of a publicly known material such as a metal (e.g., iron, ferrite, or magnetite) or an alloy of any of these metals with a metal such as aluminum or lead. Ferrite particles are particularly preferred.

The carrier used may be a resin-coated carrier prepared by coating the surfaces of magnetic particles with a resin or a dispersion-type carrier prepared by dispersing fine magnetic particles in a binder resin.

No particular limitation is imposed on the coating resin used in the resin-coated carrier. Examples of the coating resin include olefin-based resins, styrene-based resins, styrene-acrylic copolymer resins, silicone-based resins, ester resins, and fluorocarbon resins.

No particular limitation is imposed on the binder resin used in the dispersion-type resin. Examples of the binder resin include styrene-acrylic copolymer resins, polyester resins, fluorocarbon resins, and phenolic resins.

The particle diameter of the carrier is preferably 15 to 100 μm, more preferably 20 to 80 μm as a volume-based median diameter.

The volume-based median diameter of the carrier can be measured by a laser diffraction-type particle size distribution measuring device “HELOS” (manufactured by SYMPATEC) equipped with a wet dispersing device as a representative measuring device.

### Image Forming Method:

The toner of the present invention can be preferably used for commonly used electrophotographic image forming methods.

The toner of the present invention contains a hyperbranched polymer which is a homopolymer formed using an inimer having, in a single molecule thereof, a polymerizable functional group and a polymerization initiating group or is a copolymer formed using the inimer and a vinyl-based monomer. Therefore, the toner has low-temperature fixability and hot offset resistance and also has document offset resistance.

### EXAMPLES

Specific Examples of the present invention will next be described, but the invention is not limited thereto.

### Hyperbranched Polymer Production Example 1:

A 5,000 mL reaction flask was charged with 595 g of N,N-diethyldithiocarbamylmethylstyrene (hereinafter referred to as “S-DC”), 255 g of xylene, and 11.9 g of tetraethylthiuram disulfide (manufactured by Kanto Chemical Co., Inc., 2% by mass per the mass of the S-DC), and the mixture was stirred and dissolved. Inside air of the reaction flask was replaced with nitrogen under stirring, and then the reaction flask was immersed in an oil bath, and heated until the temperature inside the flask reached 120±5° C. Polymerization started when the temperature reached 120±5° C. After 12 hours, the reaction flask was removed from the oil bath and cooled to room temperature, and then 5.1 kg of cyclohexanone was added. The conversion rate after this process was 91%. The reaction mixture was subjected to reprecipitation purification using 29.8 kg of methanol and precipitate was filtrated under reduced pressure to obtain a white solid. The obtained solid was again dissolved in 4.5 kg of cyclohexanone, and the resultant solution was subjected to reprecipitation purification using 25 kg of methanol. The precipitate was filtrated under reduced pressure, and vacuum dried to obtain 512 g of a hyperbranched polymer [A1] as a white powder.

The yield was 86%. The linear equivalent mass-average molecular weight (MwL) measured by GPC was 21,000, and the mass average molecular weight (MwB) measured by GPC/MALLS was 40,000. The degree of branching was 1.90, and the polydispersity was 2.4.

### Hyperbranched Polymer Production Example 2:

Polymerization and purification were performed as in Hyperbranched Polymer Production Example 1 except that the “S-DC” was changed to “α-methacryloyl-ω-(N,N-diethyldi thiocarbamyl)di(oxyethylene) (hereinafter referred to as “MA-EO2-DC”) to thereby obtain 502 g of a hyperbranched polymer [A2] as a white powder.

The conversion rate was 90%, and the yield was 84%. The linear equivalent mass-average molecular weight (MwL) measured by GPC was 29,500, and the mass average molecular weight (MwB) measured by GPC/MALLS was 61,300. The degree of branching was 2.08, and the polydispersity was 2.4.

### Hyperbranched Polymer Production Example 3:

A 5,000 mL reaction flask was charged with 1,000 g of anisole, 0.76 g of tris(2-pyridylmethyl) amine (manufactured by Kanto Chemical Co., Inc.), and 0.57 g of CuBr₂, and the mixture was stirred and dissolved. 608 g of vinylbenzyl chloride (hereinafter referred to as “VBC”) was added under stirring, and then inside air of the reaction flask was replaced with nitrogen. 2.10 g of tin 2-ethylhexanoate (hereinafter referred to as “Sn(2EH)₂”) was added at room temperature, and then the reaction flask was immersed in an oil bath and heated until the temperature inside the flask reached 100° C. Polymerization started when the temperature reached 100±5° C. After 12 hours, the reaction flask was removed from the oil bath and cooled to room temperature, and then 4.1 kg of cyclohexanone was added. The conversion rate after this process was 93%. The reaction mixture was subjected to reprecipitation purification using 29.8 kg of methanol, and precipitate was filtrated under reduced pressure to obtain a light-yellow solid. The obtained solid was again dissolved in 4.5 kg of cyclohexanone, and the resultant solution was subjected to reprecipitation purification using 25 kg of methanol. The precipitate was filtrated under reduced pressure, and vacuum dried to obtain 535 g of a hyperbranched polymer [A3] as a white powder.

The yield was 88%. The linear equivalent mass-average molecular weight (MwL) measured by GPC was 25,500, and the mass average molecular weight: (MwB) measured by GPC/MALLS was 74,500. The degree of branching was 2.92, and the polydispersity was 2.8.

### Hyperbranched Polymer Production Example 4:

Polymerization and purification were performed as in Hyperbranched Polymer Production Example 3 except that “VBC” was changed to 1-methacryloyloxy-2-(2-bromopropyloyloxy)ethane (hereinafter referred to as “MA-Et-BPO”) to thereby obtain 530 g of a hyperbranched polymer [A4] as a white powder.

The conversion rate was 92%, and the yield was 87%. The linear equivalent mass-average molecular weight (MwL) measured by GPC was 41,000, and the mass average molecular weight (MwB) measured by GPC/MALLS was 71,000. The degree of branching was 1.73, and the polydispersity was 2.2.

### Hyperbranched Polymer Production Example 5:

Polymerization was performed as in Hyperbranched Polymer Production Example 3. In this production process, 152 g of α-methacryloyl-ω-(2-bromopropyloyloxy)di(oxyethylene) (hereinafter referred to as “MA-EO2-BPO”), 304 g of methyl methacrylate (hereinafter referred to as “MMA”), and 152 g of butyl acrylate (hereinafter referred to as “BA”) were used instead of “VBC.” More specifically, the polymerization and purification were performed as in Hyperbranched Polymer Production Example 3 except that the reaction temperature was changed to 90±5° C. to obtain 515 g of a hyperbranched polymer [A5] as a white powder.

The conversion rate was 90%, and the yield was 85%. The linear equivalent mass-average molecular weight (MwL) measured by GPC was 17,500, and the mass average molecular weight (MwB) measured by GPC/MALLS was 54,500. The degree of branching was 3.11, and the polydispersity was 2.1.

### Hyperbranched Polymer Production Example 6:

The same procedure as in Hyperbranched Polymer Production Example 1 until the reaction was performed for 12 hours was followed, and then the reaction flask was cooled to a temperature of 90° C. After the temperature reached 90° C., a mixture of 80 g of MMA and 20 g of BA was added dropwise over about 30 minutes. After completion of dropwise addition, the resultant mixture was allowed to react at 90° C.±5° C. for 12 hours. After the mixture was cooled to room temperature, reprecipitation purification was performed as in the hyperbranched polymer [A1] to obtain 591 g of a terminal-modified hyperbranched polymer [B1] as a white powder.

The conversion rate was 90%, and the yield was 85%. The linear equivalent mass-average molecular weight (MwL) measured by GPC was 29,000, and the mass average molecular weight (MwB) measured by GPC/MALLS was 49,000. The degree of branching was 1.67, and the polydispersity was 2.4.

### Hyperbranched Polymer Production Example 7:

Polymerization and purification were performed as in Hyperbranched Polymer Production Example 6 except that the hyperbranched polymer [A1] was changed to the hyperbranched polymer [A2] to thereby obtain 601 g of a terminal-modified hyperbranched polymer [B2] as a white powder.

The conversion rate was 91%, and the yield was 86%. The linear equivalent mass-average molecular weight (MwL) measured by GPC was 38,000, and the mass average molecular weight (MwB) measured by GPC/MALLS was 68,700. The degree of branching was 1.80, and the polydispersity was 2.5.

### Hyperbranched Polymer Production Example 8:

Polymerization and purification were performed as in Hyperbranched Polymer Production Example 7 except that the mixture of 80 g of MMA and 20 g of BA was changed to a mixture of 80 g of styrene (hereinafter referred to as “ST”) and 20 g of BA to thereby obtain 603 g of a terminal-modified hyperbranched polymer [B3] as a white powder.

The conversion rate was 92%, and the yield was 87%. The linear equivalent mass-average molecular weight (MwL) measured by GPC was 39,000, and the mass average molecular weight (MwB) measured by GPC/MALLS was 67,900. The degree of branching was 1.74, and the polydispersity was 2.5.

### Hyperbranched Polymer Production Example 9:

The same procedure as in Hyperbranched Polymer Production Example 3 until the reaction was performed for 12 hours was followed, and then the reaction flask was cooled to a temperature of 90° C. After the temperature reached 90° C., a mixture of 80 g of MMA and 20 g of BA was added dropwise over about 30 minutes. After completion of dropwise addition, the mixture was allowed to react at 90° C.±5° C. for 12 hours. After the mixture was cooled to room temperature, reprecipitation purification was performed as in the hyperbranched polymer [A3] to obtain 606 g of a terminal-modified hyperbranched polymer [B4] as a white powder.

The conversion rate was 92%, and the yield was 86%. The linear equivalent mass-average molecular weight (MwL) measured by GPC was 33,200, and the mass average molecular weight (MwB) measured by GPC/MALLS was 92,000. The degree of branching was 2.77, and the polydispersity was 2.6.

### Hyperbranched Polymer Production Example 10:

Polymerization and purification were performed as in Hyperbranched Polymer Production Example 9 except that the hyperbranched polymer [A3] was changed to the hyperbranched polymer [A4] to thereby obtain 601 g of a terminal-modified hyperbranched polymer [B5] as a white powder.

The conversion rate was 91%, and the yield was 85%. The linear equivalent mass-average molecular weight (MwL) measured by GPC was 58,000, and the mass average molecular weight (MwB) measured by GPC/MALLS was 100,700. The degree of branching was 1.73, and the polydispersity was 2.4.

### Hyperbranched Polymer Production Example 11:

Polymerization and purification were performed as in Hyperbranched Polymer Production Example 9 except that the hyperbranched polymer [A3] was changed to the hyperbranched polymer [A5] to thereby obtain 598 g of a terminal-modified hyperbranched polymer [B6] as a white powder.

The conversion rate was 91%, and the yield was 84%. The linear equivalent mass-average molecular weight (MwL) measured by GPC was 24,500, and the mass average molecular weight (MwB) measured by GPC/MALLS was 71,800. The degree of branching was 2.93, and the polydispersity was 2.0.

TABLE 1

| | | | | TERMINAL- | | DEGREE OF | |
|---|---|---|---|---|---|---|---|
| HYPERBRANCHED | POLYMERIZATION | | | MODIFIED | MwL | BRANCHING | POLYDISPERSITY |
| POLYMER NO. | PROCESS | INIMER | COMONOMER | MONOMER | (GPC) | (MwB/MwL) | (MwL/Mn) |
| [A1] | THERMAL | S-DC | NONE | NONE | 21000 | 1.90 | 2.4 |
| | POLYMERIZATION | | | | | | |
| [A2] | THERMAL | MA-EO2-DC | NONE | NONE | 29500 | 2.08 | 2.4 |
| | POLYMERIZATION | | | | | | |
| [A3] | ATRP | VBC | NONE | NONE | 25500 | 2.92 | 2.8 |
| [A4] | ATRP | MA-Et-BPO | NONE | NONE | 4100 | 1.73 | 2.2 |
| [A5] | ATRP | MA-EO2-BPO | MMA/BA | NONE | 17500 | 3.11 | 2.1 |
| [B1] | THERMAL | S-DC | NONE | MMA/BA = 8/2 | 29000 | 1.67 | 2.4 |
| | POLYMERIZATION | | | | | | |
| [B2] | THERMAL | MA-EO2-DC | NONE | MMA/BA = 8/2 | 38000 | 1.80 | 2.5 |
| | POLYMERIZATION | | | | | | |
| [B3] | THERMAL | MA-EO2-DC | NONE | ST/BA = 8/2 | 39000 | 1.74 | 2.5 |
| | POLYMERIZATION | | | | | | |
| [B4] | ATRP | VBC | NONE | MMA/BA = 8/2 | 33200 | 2.77 | 2.6 |
| [B5] | ATRP | MA-Et-BPO | NONE | MMA/BA = 8/2 | 58000 | 1.73 | 2.4 |
| [B6] | ATRP | MA-EO2-DC | MMA/BA | MMA/BA = 8/2 | 24500 | 2.93 | 2.0 |

### Polyester Resin Synthesis Example 1:

A reaction vessel equipped with a stirrer, a nitrogen introduction tube, a temperature sensor, and a rectifying column was charged with 4.2 parts by mass of fumaric acid and 78 parts by mass of terephthalic acid which serve as polyvalent carboxylic acids, and 152 parts by mass of a 2 mole propylene oxide adduct of 2,2-bis(4-hydroxyphenyl)propane and 48 parts by mass of a 2 mole ethylene oxide adduct of 2,2-bis(4-hydroxyphenyl)propane which serve as polyalcohols. The mixture was heated to 190° C. over 1 hour. After the reaction system was confirmed to be uniformly stirred, a catalyst Ti(OBu)₄ was added (in an amount of 0.006% by mass per the total amount of the polyvalent carboxylic acids).

Then the temperature was increased to 240° C. over 6 hours while water generated was removed by evaporation. The dehydration condensation reaction for polymerization was further continued at 240° C. for 6 hours to obtain a polyester resin [1]. The molecular weight of the obtained polyester resin [1] was measured by GPC. The mass average molecular weight (Mw) was found to be 15,300 (HLC-8 120GPC, manufactured by Tosoh Corporation, converted using a styrene standard material).

### Styrene-Acrylic Copolymer Resin Synthesis Example 1:

A pressurizable reaction vessel equipped with a reflux tube, a stirrer, a temperature sensor, a nitrogen introduction tube, a dropping device, and a decompression device was charged with 250 parts by mass of methanol, 150 parts by mass of 2-butanone and 100 parts by mass of 2-propanol which serve as solvents, and 55.0 parts by mass of styrene, 5.0 parts by mass of methyl methacrylate, 33 parts by mass of butyl acrylate, 7.0 parts by mass of methacrylic acid, and 2.0 parts by mass of n-octyl-3-mercaptopropionate which serve as polymerizable monomers. The mixture was heated to a reflux temperature under stirring. A solution prepared by diluting 1 part by mass of t-butylperoxy-2-ethylhexanoate as a polymerization initiator with 20 parts by mass of 2-buthanon was added dropwise over 30 minutes, and stirring was continued for 5 hours and then stopped. The reaction mixture was subjected to reprecipitation purification using 3,000 parts by mass of methanol, and precipitate was filtrated under reduced pressure to obtain a while solid. The obtained solid was again dissolved in 400 parts by mass of cyclohexanone, and the resultant solution was subjected to reprecipitation purification using 2,500 parts by mass of methanol. The precipitate was filtrated under reduced pressure, and vacuum dried to thereby obtain a styrene-acrylic copolymer resin [1] as a white powder. The molecular weight of the obtained styrene-acrylic copolymer resin [1] was measured by GPC, and the mass average molecular weight (Mw) was found to be 22,000. Mw/Mn was 3.2.

### Binder Resin Particle Dispersion Preparation Example 1:

A product obtained by coarsely pulverizing the polyester resin [1] using a hummer mill and the hyperbranched polymer [A1] were used to prepare a binder resin particle dispersion [1] as follows.

A reaction vessel equipped with anchor blades for providing agitation power was charged with 180 parts by mass of methyl ethyl ketone and 60 parts by mass of isopropyl alcohol (IPA), and nitrogen was introduced to the reaction vessel to replace air in the system with nitrogen. Then 261 parts by mass of the polyester resin [1] and 30 parts by mass of the hyperbranched polymer [A1] were slowly added and dissolved under stirring while the reaction vessel was heated to 60° C. using an oil bath in the system. Then parts by mass of 10% ammonia water was added thereto, and 1,500 parts by mass of deionized water was added under stirring using a metering pump. Emulsification was stopped when the emulsion system assumed a milk white color and the stirring viscosity was reduced.

The resin particle dispersion was drawn through a pressure difference caused by centrifugal force to transfer the emulsion system to a 3 L separable flask equipped with stirring blades for forming a wet wall on the inner wall of a reaction tank, a reflux device, and a decompression device including a vacuum pump. The resin particle dispersion was stirred at a reaction tank inner wall temperature of 58° C. under a reduced pressure (a pressure inside the reaction tank) of 8 kPa [abs]. When the amount of ref lux reached 650 parts by mass, the procedure was ended. Then the pressure inside the reaction tank was returned to normal pressure, and the reaction tank was cooled to room temperature under stirring. The volume-based median diameter of the binder resin particles dispersed in the obtained binder resin particle dispersion [1] was 162 nm.

### Binder Resin Particle Dispersion Preparation Example 2:

A binder resin particle dispersion [2] was prepared as in Binder Resin Particle Dispersion Preparation Example 1 except that the hyperbranched polymer [A1] was changed to the hyperbranched polymer [A2]. The volume-based median diameter of the binder resin particles dispersed in the obtained binder resin particle dispersion [2] was 167 nm.

### Binder Resin Particle Dispersion Preparation Example 3:

A binder resin particle dispersion [3] was prepared as in Binder Resin Particle Dispersion Preparation Example 1 except that the hyperbranched polymer [A1] was changed to the hyperbranched polymer [A3]. The volume-based median diameter of the binder resin particles dispersed in the obtained binder resin particle dispersion [3] was 177 nm.

### Binder Resin Particle Dispersion Preparation Example 4:

A binder resin particle dispersion [4] was prepared as in Binder Resin Particle Dispersion Preparation Example 1 except that the hyperbranched polymer [A1] was changed to the hyperbranched polymer [A4]. The volume-based median diameter of the binder resin particles dispersed in the obtained binder resin particle dispersion [4] was 169 nm.

### Binder Resin Particle Dispersion Preparation Example 5:

A binder resin particle dispersion [5] was prepared as in Binder Resin Particle Dispersion Preparation Example 1 except that the hyperbranched polymer [A1] was changed to the hyperbranched polymer [A5]. The volume-based median diameter of the binder resin particles dispersed in the obtained binder resin particle dispersion [5] was 182 nm.

### Binder Resin Particle Dispersion Preparation Example 6:

A binder resin particle dispersion [6] was prepared as in Binder Resin Particle Dispersion Preparation Example 1 except that the hyperbranched polymer [A1] was changed to the hyperbranched polymer [B1]. The volume-based median diameter of the binder resin particles dispersed in the obtained binder resin particle dispersion [6] was 189 nm.

### Binder Resin Particle Dispersion Preparation Example 7:

A binder resin particle dispersion [7] was prepared as in Binder Resin Particle Dispersion Preparation Example 1 except that the hyperbranched polymer [A1] was changed to the hyperbranched polymer [B2]. The volume-based median diameter of the binder resin particles dispersed in the obtained binder resin particle dispersion [7] was 172 nm.

### Binder Resin Particle Dispersion Preparation Example 8:

A binder resin particle dispersion [8] was prepared as in Binder Resin Particle Dispersion Preparation Example 1 except that the hyperbranched polymer [A1] was changed to the hyperbranched polymer [B3]. The volume-based median diameter of the binder resin particles dispersed in the obtained binder resin particle dispersion [8] was 131 nm.

### Binder Resin Particle Dispersion Preparation Example 9:

A binder resin particle dispersion [9] was prepared as in Binder Resin Particle Dispersion Preparation Example 1 except that the hyperbranched polymer [A1] was changed to the hyperbranched polymer [B4]. The volume-based median diameter of the binder resin particles dispersed in the obtained binder resin particle dispersion [9] was 197 nm.

### Binder Resin Particle Dispersion Preparation Example 10:

A binder resin particle dispersion [10] was prepared as in Binder Resin Particle Dispersion Preparation Example 1 except that the hyperbranched polymer [A1] was changed to the hyperbranched polymer [B5]. The volume-based median diameter of the binder resin particles dispersed in the obtained binder resin particle dispersion [10] was 191 nm.

### Binder Resin Particle Dispersion Preparation Example 11:

A binder resin particle dispersion [11] was prepared as in Binder Resin Particle Dispersion Preparation Example 1 except that the hyperbranched polymer [A1] was changed to the hyperbranched polymer [B6]. The volume-based median diameter of the binder resin particles dispersed in the obtained binder resin particle dispersion [11] was 184 nm.

### Binder Resin Particle Dispersion Preparation Example 12:

A binder resin particle dispersion [12] was prepared as in Binder Resin Particle Dispersion Preparation Example 1 except that the polyester resin [1] was not added and the hyperbranched polymer [A1] was changed to 291 parts by mass of the hyperbranched polymer [A2]. The volume-based median diameter of the binder resin particles dispersed in the obtained binder resin particle dispersion [12] was 201 nm.

### Binder Resin Particle Dispersion Preparation Example 13:

A binder resin particle dispersion [13] was prepared as in Binder Resin Particle Dispersion Preparation Example 12 except that the hyperbranched polymer [A2] was changed to the hyperbranched polymer [A5]. The volume-based median diameter of the binder resin particles dispersed in the obtained binder resin particle dispersion [13] was 194 nm.

### Binder Resin Particle Dispersion Preparation Example 14:

A binder resin particle dispersion [14] was prepared as in Binder Resin Particle Dispersion Preparation Example 12 except that the hyperbranched polymer [A2] was changed to the hyperbranched polymer [B1]. The volume-based median diameter of the binder resin particles dispersed in the obtained binder resin particle dispersion [14] was 204 nm.

### Binder Resin Particle Dispersion Preparation Example 15:

A binder resin particle dispersion [15] was prepared as in Binder Resin Particle Dispersion Preparation Example 12 except that the hyperbranched polymer [A2] was changed to the hyperbranched polymer [B2]. The volume-based median diameter of the binder resin particles dispersed in the obtained binder resin particle dispersion [15] was 189 nm.

### Binder Resin Particle Dispersion Preparation Example 16:

A binder resin particle dispersion [16] was prepared as in Binder Resin Particle Dispersion Preparation Example 12 except that the hyperbranched polymer [A2] was changed to the hyperbranched polymer [B6]. The volume-based median diameter of the binder resin particles dispersed in the obtained binder resin particle dispersion [16] was 209 nm.

### Binder Resin Particle Dispersion Preparation Example 17:

A binder resin particle dispersion [17] was prepared as in Binder Resin Particle Dispersion Preparation Example 7 except that the polyester resin [1] was changed to the styrene-acrylic copolymer resin [1]. The volume-based median diameter of the binder resin particles dispersed in the obtained binder resin particle dispersion [17] was 194 nm.

### Binder Resin Particle Dispersion Preparation Example 18:

A binder resin particle dispersion [18] was prepared as in Binder Resin Particle Dispersion Preparation Example 8 except that the polyester resin [1] was changed to the styrene-acrylic copolymer resin [1]. The volume-based median diameter of the binder resin particles dispersed in the obtained binder resin particle dispersion [18] was 199 nm.

### Binder Resin Particle Dispersion Preparation Example 19:

A binder resin particle dispersion [19] was prepared as in Binder Resin Particle Dispersion Preparation Example 11 except that 30 parts by mass of the hyperbranched polymer [B6] was changed to 5 parts by mass thereof. The volume-based median diameter of the binder resin particles dispersed in the obtained binder resin particle dispersion [19] was 179 nm.

### Binder Resin Particle Dispersion Preparation Example 20:

A binder resin particle dispersion [20] was prepared as in Binder Resin Particle Dispersion Preparation Example 1 except that the hyperbranched polymer [A1] was not added but instead 291 parts by mass of the polyester resin [1] was added. The volume-based median diameter of the binder resin particles dispersed in the obtained binder resin particle dispersion [20] was 165 nm.

### Binder Resin Particle Dispersion Preparation Example 21:

A binder resin particle dispersion [21] was prepared as in Binder Resin Particle Dispersion Preparation Example 17 except that the hyperbranched polymer [B2] was not added but instead 291 parts by mass of the styrene-acrylic copolymer resin [1] was added. The volume-based median diameter of the binder resin particles dispersed in the obtained binder resin particle dispersion [21] was 184 nm.

### Colorant Particle Dispersion Preparation Example 1:

50 Parts by mass of C.I. Pigment Blue 15:3 (manufactured by DIC) serving as a colorant and 5 parts by mass of an ionic surfactant (NEOGEN RK, manufactured by DAI-ICHI KOGYO SEIYAKU Co., Ltd.) were mixed with and dissolved in 195 parts by mass of ion exchanged water, and the mixture was subjected to dispersion treatment for 10 minutes using a homogenizer “ULTRA-TURRAX” (manufactured by IKA) to prepare a colorant particle dispersion [1]. The volume-based median diameter of the colorant particles dispersed in the obtained colorant particle dispersion [1] was 185 nm.

### Parting Agent Particle Dispersion Preparation Example 1:

50 Parts by mass of paraffin wax “FNP92” (manufactured by Nippon Seiro Co., Ltd., melting pint: 91° C.), an ionic surfactant “NEOGEN RK” (manufactured by Dai-Ichi Kogyo Seiyaku Co., Ltd.), and 195 parts by mass of ion exchanged water were heated to 600° C., dispersed sufficiently using a homogenizer “ULTRA-TURRAX T50” (manufactured by IKA), and then subjected to dispersion treatment using a pressure ejection-type Gaulin homogenizer to prepare a parting agent particle dispersion [1]. The volume-based median diameter of the parting agent particles dispersed in the obtained parting agent particle dispersion [1] was 170 nm.

### Toner Production Example 1:

In a reaction vessel equipped with a stirrer, a temperature sensor, a condenser tube, and a nitrogen introduction tube, a stainless steel-made round-bottom flask was charged with 900 parts by mass of the binder resin particle dispersion [1], 60 parts by mass of the colorant particle dispersion [1], and 60 parts by mass of the parting agent particle dispersion [1], and these were mixed and stirred using a homogenizer “ULTRA-TURJAX” (manufactured by IKA). 0.41 Parts by mass of poly-sodium chloride (manufactured by Asada Chemical Industry Co., Ltd.) was added to the mixture, and the dispersion treatment using the “ULTRA-TURRAX” was continued. The mixture was heated to 47° C. in a heating oil bath while the interior of the flask was stirred. The mixture was held at 47° C. for 60 minutes.

Then the pH of the system was adjusted to 8.0 at a temperature of 47° C. using a 0.5 Mol/L aqueous sodium hydroxide solution. The flask was sealed and then heated to and held at 90° C. for 3 hours while stirring was continued using a magnetic seal.

After completion of the reaction, the reaction mixture was cooled, filtrated, and washed sufficiently with deionized water, and solid-liquid separation was performed by Nutsche suction filtration.

The resultant reaction mixture was again dispersed in 3 L of ion exchanged water at 40° C. and stirred and washed at 300 rpm for 15 minutes.

This procedure was further repeated 5 times. After the pH of the filtrate became 7.01 at a temperature of 40° C., the electric conductivity became 9.8 μS/cm, and the surface tension became 71.1 Nm, then solid-liquid separation was performed using a No. 5A filter paper by Nutsche suction filtration. Then vacuum drying was performed at 40° C. for 12 hours to obtain a toner [1] composed of toner particles. The volume-based median diameter of the obtained toner [1] was 5.4 μm.

### Toner Production Examples 2 to 21:

loners [2] to [21] were obtained as in Toner Production Example 1 except that the binder resin particle dispersion [1] was changed to the binder resin particle dispersions [2] to [21], respectively.

### Developer Production Examples 1 to 21:

Developers [1] to [21] were produced by mixing the produced toners [1] to [21] with a silicone resin-coated ferrite carrier having a volume average particle diameter of 60 nm such that the toner concentrations in the developers were 6% by mass.

### Examples 1 to 19 and Comparative Examples 1 and 2

One of the obtained developers [1] to [21] was charged with in an image forming apparatus “bizhub PRO C6500,” (manufactured by Konica Minolta Business Technologies, Inc.) and evaluated as follows.

A fixing unit in the image forming apparatus used was modified such that the surface temperature of a fixing roller could be changed in steps of 5° C. in the range of 100 to 200° C. The results are shown in TABLE 2.

### (1) Low-Temperature Fixability

The evaluation apparatus modified such that the temperature of the fixing roller could be changed in steps of 5° C. in the range of 100° C. or higher was used to evaluate the low-temperature fixability in a room temperature-room humidity environment (20° C., 55% RH) by the following criterion for fixability onto a fold. Measurement was performed on a fold at different temperature settings of the fixing roller. Specifically, the temperature setting was increased in steps of 5° C. in the range of 100° C. or higher. The temperature at which the fixability onto the fold became 80% or higher was defined as a minimum fixing temperature. A toner with a minimum fixing temperature of 160° C. or lower was judged as pass.

To determine the fixability (strength) onto a fold, the fixation rate of a toner image on a fold of a sheet was evaluated. More specifically, the degree of exfoliation of the toner from a fixed toner image on the fold after the sheet was folded with the fixed toner image inward was used to evaluate the fixation rate.

To determine the fixation rate, a sheet with a solid image (image density: 0.8) was folded with the image surface inward, and the fold was rubbed three times with a finger. Then the folded sheet was unfolded, and the image was wiped three times with “JK Wiper” (manufactured by Nippon Paper Crecia Co., Ltd.). The fixation rate was computed from the image densities of the solid image on the fold before and after folding using the following formula.

Fixation rate (%)=(image density after folding)/(image density before folding)×100

### (2) Hot Offset Resistance

The evaluation apparatus modified such that the temperature of the fixing roller could be changed in steps of 5° C. in the range of 100° C. to 200° C. was used to evaluate the hot offset resistance in a high temperature-high humidity environment (30° C., 80% RH) by the following evaluation criterion. An A4 sheet with a solid cyan band-shaped image having a width of 5 cm and extending in a direction orthogonal to a sheet conveying direction was conveyed longitudinally, and the image was fixed while the fixing was performed at increased different temperature settings of the fixing roller. Then the fixed image was visually checked.

The temperature at which roughness or small unevenness in gloss was found on the image surface was considered as hot-offset temperature.

A toner with a fixable temperature range (=hot-offset temperature−minimum fixing temperature) of 35° C. or higher was judged as pass.

### (3) Document Offset Resistance

A dedicated finisher “FS-608” (manufactured by Konica Minolta Business Technologies, Inc.) was attached to an image forming apparatus “bizhub PRO C6500.” An automatic bookbinding test was repeated 50 times. In each test, paper with a basis weight of 64 g/m² was used, and 20 saddle stitched booklets (each composed of 5 sheets) were produced at a pixel ratio per page of 50%. The printed booklets were naturally cooled to room temperature, and all the pages were visually checked. A page with a fixed image having the largest degree of image defects was evaluated by the following evaluation criteria. Ranks 3 and 4 are pass levels.

### —Evaluation Criteria—

Rank 1: An image region stuck to another page. Therefore, the degree of image defects such as white spots was high, and transfer of the image to a non-image region was clearly found.

Rank 2: The edges of the paper sheets were not neatly aligned and were cut with images on some pages inclined. Unevenness in gloss indicating the adhesion of an image was found in image regions.

Rank 3: There was no page having edges cut with the edges not neatly aligned and with the image on the page inclined. The level of gloss unevenness was practically acceptable.

Rank 4: No image defects and no image transfer were found on both the image regions and non-image regions.

TABLE 2

| | | | | | EVALUATION RESULTS | | | |
|---|---|---|---|---|---|---|---|---|
| | | | | | LOW- | | | |
| | | BINDER RESIN | | | TEMPERATURE | | | |
| | | HYPERBRANCHED | | | FIXABILITY | HOT-OFFSET RESISTANCE | | |
| | | POLYMER | | | MINIMUM | | FIXABLE | |
| | | | CONTENT | ADDITIONAL | FIXING | HOT-OFFSET | TEMPERATURE | DOCUMENT |
| | TONER | | (% BY | RESIN | TEMPERATURE | TEMPERATURE | RANGE | OFFSET |
| | NO. | No. | MASS) | No. | (° C.) | (° C.) | (° C.) | RESISTANCE |
| EXAMPLE 1 | [1] | [A1] | 10.3 | POLYESTER RESIN [1] | 135 | 185 | 50 | 3 |
| EXAMPLE 2 | [2] | [A2] | 10.3 | POLYESTER RESIN [1] | 140 | 195 | 55 | 4 |
| EXAMPLE 3 | [3] | [A3] | 10.3 | POLYESTER RESIN [1] | 135 | 190 | 55 | 4 |
| EXAMPLE 4 | [4] | [A4] | 10.3 | POLYESTER RESIN [1] | 145 | 185 | 40 | 3 |
| EXAMPLE 5 | [5] | [A5] | 10.3 | POLYESTER RESIN [1] | 140 | 195 | 55 | 4 |
| EXAMPLE 6 | [6] | [B1] | 10.3 | POLYESTER RESIN [1] | 140 | 195 | 55 | 4 |
| EXAMPLE 7 | [7] | [B2] | 10.3 | POLYESTER RESIN [1] | 140 | 200 | 60 | 4 |
| EXAMPLE 8 | [8] | [B3] | 10.3 | POLYESTER RESIN [1] | 145 | 200 | 55 | 4 |
| EXAMPLE 9 | [9] | [B4] | 10.3 | POLYESTER RESIN [1] | 135 | 195 | 60 | 4 |
| EXAMPLE 10 | [10] | [B5] | 10.3 | POLYESTER RESIN [1] | 145 | NOT | 55< | 4 |
| | | | | | | OCCURRED | | |
| EXAMPLE 11 | [11] | [B6] | 10.3 | POLYESTER RESIN [1] | 140 | NOT | 60< | 4 |
| | | | | | | OCCURRED | | |
| EXAMPLE 12 | [12] | [A2] | 100 | NONE | 160 | NOT | 40< | 4 |
| | | | | | | OCCURRED | | |
| EXAMPLE 13 | [13] | [A5] | 100 | NONE | 155 | NOT | 45< | 4 |
| | | | | | | OCCURRED | | |
| EXAMPLE 14 | [14] | [B1] | 100 | NONE | 150 | NOT | 50< | 4 |
| | | | | | | OCCURRED | | |
| EXAMPLE 15 | [15] | [B2] | 100 | NONE | 155 | NOT | 45< | 4 |
| | | | | | | OCCURRED | | |
| EXAMPLE 16 | [16] | [B6] | 100 | NONE | 150 | NOT | 50< | 4 |
| | | | | | | OCCURRED | | |
| EXAMPLE 17 | [17] | [B2] | 10.3 | STYRENE-ACRYLIC | 155 | 200 | 45 | 4 |
| | | | | COPOLYMER | | | | |
| | | | | RESIN [1] | | | | |
| EXAMPLE 18 | [18] | [B3] | 10.3 | STYRENE-ACRYLIC | 160 | NOT | 40< | 4 |
| | | | | COPOLYMER | | OCCURRED | | |
| | | | | RESIN [1] | | | | |
| EXAMPLE 19 | [19] | [B6] | 1.88 | POLYESTER RESIN [1] | 135 | 190 | 55 | 3 |
| COMPAR- | [20] | NONE | — | POLYESTER RESIN [1] | 140 | 165 | 25 | 1 |
| ATIVE | | | | | | | | |
| EXAMPLE 1 | | | | | | | | |
| COMPAR- | [21] | NONE | — | STYRENE-ACRYLIC | 160 | 180 | 20 | 2 |
| ATIVE | | | | COPOLYMER | | | | |
| EXAMPLE 2 | | | | RESIN [1] | | | | |

The above results show that the use of the toner of the present invention allows the temperature at which hot offset occurs to be shifted to a high-temperature side while excellent low-temperature fixability is maintained. Therefore, the fixable temperature range can be increased, and the toner can be used for various fixing processes. In addition, the fixing separability of the toner is improved, and the toner obtained has high document offset resistance after fixing.

1. A toner for electrostatic image development, comprising a hyperbranched polymer which is a homopolymer formed using an inimer having, in a single molecule thereof, a polymerizable functional group and a polymerization initiating group or is a copolymer formed using the inimer and a vinyl-based monomer.

2. The toner for electrostatic image development according to claim 1, wherein the hyperbranched polymer is a terminal-modified hyperbranched polymer.

3. The toner for electrostatic image development according to claim 1, wherein the hyperbranched polymer is obtained by a living radical polymerization process.

4. The toner for electrostatic image development according to claim 3, wherein the living radical polymerization process is an atom transfer radical polymerization (ATRP) process.

5. The toner for electrostatic image development according to claim 3, wherein the living radical polymerization process is a thermal polymerization process using a dithiocarbamate compound represented by the following formula (1): 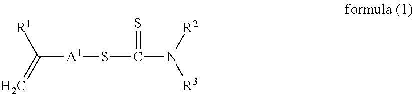
(in the formula (1), R¹ represents a hydrogen atom or a methyl group, R² and R³ each independently represent an alkyl group having 1 to 5 carbon atoms, a hydroxyalkyl group having 1 to 5 carbon atoms, or an arylalkyl group having 7 to 12 carbon atoms, R² and R³ may be bonded to each other to form a ring together with a nitrogen atom, and A¹ represents at least one of groups represented by the following formulas (2) and (3)), 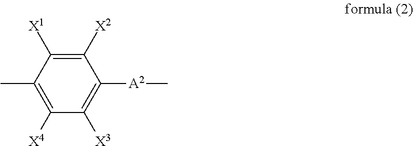
(in the formula (2), A² represents a linear, branched, or cyclic alkylene group having 1 to 30 carbon atoms and optionally having an ether bond or an ester bond, and X¹ to X⁴ each independently represent a hydrogen atom, an alkyl group having 1 to 20 carbon atoms, an alkoxy group having 1 to 20 carbon atoms, a halogen atom, a nitro group, a hydroxy group, an amino group, a carboxyl group, or a cyano group), 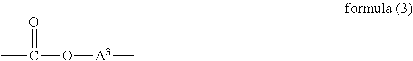
(in the formula (3), A³ represents a linear, branched, or cyclic alkylene group having 1 to 30 carbon atoms and optionally having an ether bond or an ester bond).

6. The toner for electrostatic image development according to claim 1, wherein a linear equivalent mass-average molecular weight (MwL) of the hyperbranched polymer measured by gel permeation chromatography (GPC) is 1,000 to 1,000,000.

7. The toner for electrostatic image development according to claim 1, wherein a linear equivalent mass-average molecular weight (MwL) of the hyperbranched polymer measured by gel permeation chromatography (GPC) is 2,000 to 500,000.

8. The toner for electrostatic image development according to claim 1, wherein a linear equivalent mass-average molecular weight (MwL) of the hyperbranched polymer measured by gel permeation chromatography (GPC) is 5,000 to 100,000.

9. The toner for electrostatic image development according to claim 1, wherein the hyperbranched polymer has a degree of branching of 1.2 to 10.

10. The toner for electrostatic image development according to claim 1, wherein the hyperbranched polymer has a polydispersity of 10 or less.
